(19) United States
(12) Patent Application Publication
(10) Pub. No.: US 2007/0246609 A1
(43) Pub. Date: Oct. 25, 2007

(54) Method for Expelling a Fluid Medium from an Aircraft

(76) Inventors: Valery Ilyich Smetannikov, Moscow (RU); Andrey Valeryevich Smetannikov, Moscow (RU); Nikolay Dmitriyevich Talikov, Moscow (RU); Pavel Michailovich Nikolayev, Feodosiya (UA)

Correspondence Address: MCDERMOTT WILL & EMERY LLP, 600 13TH STREET, N.W., WASHINGTON, DC, 20005-3096, US

(21) Appl. No.: 11/662,089

(22) PCT Filed: Sep. 9, 2004
(86) PCT No.: PCT/RU04/00349

§ 371 Date: Mar. 7, 2007

(51) Int. Cl. B64D 1/00

(52) U.S. Cl. 244/136

(57) ABSTRACT

The invention relates to releasing a fluid medium from cargo and specialised airplanes, mainly for fighting large-scale forest fires and the similar by water or extinguishing agents. The inventive method consists in expelling said fluid medium from an on-board container by imparting to said medium a speed relative to the aircraft speed, preferably equal or opposite thereto. The fluid medium expel from the container is carried out by means of an expelling device which is exposed to the action of the aerodynamic force of an incoming air stream produced by the aircraft movement. The container is embodied in the form of an elongated tank (one or two) comprising a conical nozzle and a cylindrical input pipe provided with a valve. The piston-shaped expelling means is embodied in the form of a watertight parachute which is connected to a pilot chute by a flexible rod through an exhaust pipe. Said pilot chute is introduced into the incoming air-stream above a jettison location (fire spot), thereby producing an aerodynamic force for expelling the fluid from the container. A fluid stream falling from a low-height (˜50 m) with a low- or zero horizontal speed, disintegrates directly near the earth surface, thereby forming a protective band (3-4 m width) having a required fluid concentration (5-7 l/m²) on the path of the fire proliferation. Said invention makes it possible to efficiently expel a fluid medium using simple low energy-consuming means without atomising and with a high localisation accuracy, thereby ensuring a highly cost-effective fire fighting by means of aviation facilities.

### TECHNICAL FIELD

The invention relates to jettisoning or ejecting fluid, bulk, etc. cargoes in flight and is intended, predominantly for jettisoning the fluid medium from the transport or specialized aircrafts, mainly when extinguishing big forest and similar fires using water or extinguishers.

### PRIOR ART

There are known methods for jettisoning a fluid medium from a board of an airborne vehicle, in particular for fire fighting. To this end the helicopters are usually used or planes flying at an enough low altitude with capacities for water or other extinguishing fluid (a mix, a solution, etc.).

However the helicopter has a limited carrying capacity and during one mission it can extinguish a fire only on a small area. When pouring water from the flying plane most of it is sprayed by a counter flow of air and does not create the concentration required for suppressing the fire.

For improving the situation they add chemical foam formers to water but this appreciably increases the cost of fire extinguishing.

Besides at large fires when the area of the seat of fire can make hundreds and thousand hectares, it is required to organize hundreds and thousand missions of aircrafts for extinguishing fire from above that is practically impossible.

The unique efficient way for suppressing a large-scale seat of fire is to isolate it using a very long protective frontier several meters in width with a further backfire.

For this purpose it is necessary to reduce the dispersion of the fluid medium caused by the counter flow of air that is possible by reducing the speed of this stream (in the limit down to zero), i.e. by imposing to this medium the speed corresponding to the speed of the aircraft in the direction essentially opposite to the direction of flight of the aircraft.

In the U.S. Pat. No. 6,622,966 A; 23 Sep. 2003 there is described a pumping means and a feed distribution pipe for imposing to jets of the dropped fluid a certain speed relative to the aircraft.

In the U.S. Pat. No. 5,549,259 A; 27 Aug. 1996 being the closest analogue, there is used an ejecting pipe leading from a container with an extinguishing fluid to the tail-end of a special aircraft; along the pipe there are turbines for giving a speed to the fluid in the direction opposite to movement of the aircraft.

The drawback of the mentioned technical decisions is a rather high level of power required for powering such pumps or turbines increasing the weight of the aircraft and decreasing the relative weight of onboard extinguishing means thus lowering the profitability of the above method.

It is also known from the previous art that the efficiency of jettisoning of the fluid from flying aircrafts may be somewhat increased by making the elongated tank with the fluid inclined towards the tail-end of the aircraft.

Due to such an inclination the fluid gets an increased counter speed merging self-flowing through a pull-out outlet placed at the bottom level of the tail-end of the aircraft. The given technical decisions are described in the patents U.S. Pat. No. 4,195,693 A; 1 Apr. 1980 and RU 2033828 C1, 30 Apr. 1995.

However, in this case it is not possible to receive enough high counter speed of fluid emission (for example, equal to the speed of flight of the aircraft), and this speed would not be constant from the beginning to the end of jettisoning thus providing for scattering and dispersion of parts of the fluid.

### DISCLOSURE OF THE INVENTION

The task of the present invention is to increase the efficiency of directed jettisoning of the fluid medium, mainly water or extinguisher for isolating and extinguishing fires on a large area using such airborne vehicles as transport or special aircrafts.

The technical result of the invention consists in maintaining an economy-type jettisoning of the fluid medium, without dispersion down to small concentration and with increased accuracy of confinement, mainly from the windward side before the fire front, from the board of an airborne vehicle (aircraft) flying at a significant speed, for creating a protective frontier on the way of distribution of a fire front.

The solution of the task in view for obtaining the specified technical result is reached by the fact that in the proposed method for jettisoning the fluid medium from the board of an airborne vehicle including pushing out this medium from the tank placed onboard the aircraft, with imposing to this medium the speed in the direction in essence opposite to the direction of flight of the aircraft, the medium from the specified tank is taken with the help of a pull-out parachute.

In the preferred embodiment, the fluid medium is placed in an elongated tank having the shape of a cylinder or close to it, with a conical nozzle and a cylindrical outlet fitting which section and length provide the required flow of the fluid medium from the tank, where for displacing means a piston made as a watertight parachute for the fluid medium is used that is connected by a flexible rod with a pull-out parachute that is to be led in the aircraft approach flow for obtaining the necessary aerodynamic force thus eliminating powerful power units onboard the aircraft.

Thus the area of the pull-out parachute is preferably chosen such as to obtain the fluid medium speed equal to the absolute value of speed of movement of the airborne vehicle.

For eliminating the risk of hitting the pull-out parachute by the jet of fluid medium the specified tank is mounted with an inclination aside the tail-end of the airborne vehicle, while the specified outlet fitting of the tank is placed in the same end of the airborne vehicle.

According to one of the basic applications of the invention, the water or extinguisher based on other nonflammable fluid is used for the fluid medium.

Thus in the proposed method the necessary speed relative to the airborne vehicle is imposed to the fluid medium due to the approach air flow. Thus the fluid from the tank in the plane is not self-flowing, it is forced out mainly with the help of a piston connected to a parachute, the choice of the area of the latter is a rather simple way to adjust the flow and speed of jettisoning the fluid. When falling from a low altitude (˜50 m), with small horizontal speed (˜0 km/s) relative to the ground, the jet of fluid begins to starts to break up directly over the surface of the ground, creating on a way of fire a protective frontier (3 to 4 m width) having the necessary concentration of fluid (5 to 7 liter per m²) creating the basis for a backfire.

### DISCLOSURE OF FIGURES

The essence of the invention is illustrated by the following detailed description of an example of its embodiment with the figures where:

FIG. 1—basic components of the device realizing the preferred embodiment of the proposed method (side view in section);

FIG. 2—the same, top view

### THE BEST EMBODIMENT OF THE PROPOSED INVENTION

The invention can be realized for a wide range of airborne vehicles, however it is preferred to use it in aircrafts having enough power and load-carrying capacity, capable to make steady flight at a rather low altitude (−50 m) at moderate speeds (˜260-280 km/h), with midair towage of a pull-out parachute having a required area (˜50 m²).

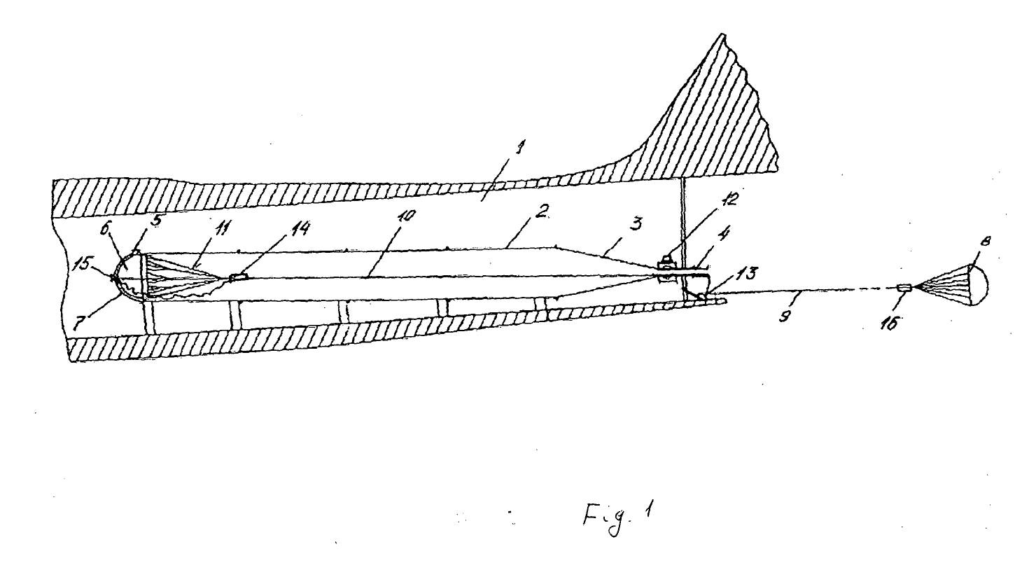

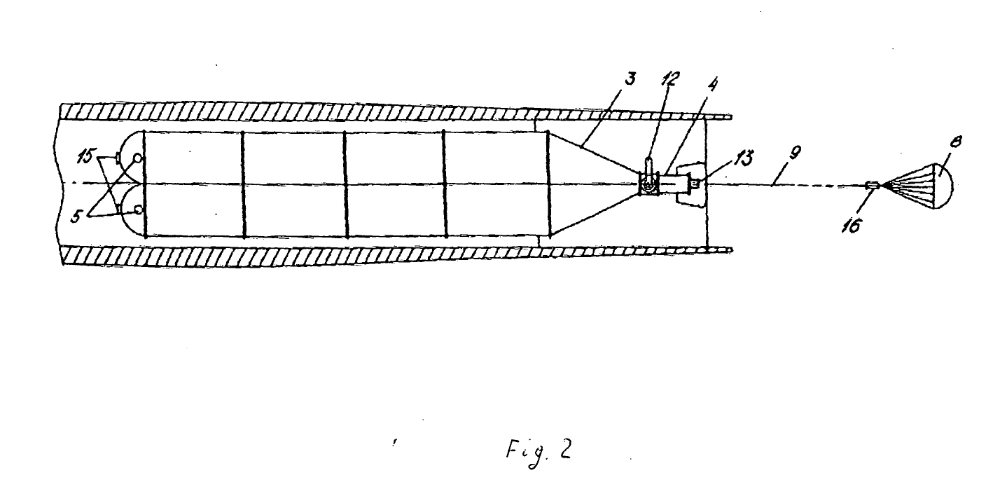

The device for realizing the preferred embodiment of the proposed method includes a tank 2 for the fluid medium (a liquid, for example, water) mounted in the cargo compartment 1 of an aircraft, having conical nozzle 3 and a cylindrical outlet fitting 4 (FIGS. 1-2).

Inside the tank 2 having a refueling branch pipe 5, the flexible piston 6 having the shape of a parachute made from a watertight fabric is placed. In its starting position this piston can be fixed to the internal surface of the bottom 7 by any known method, for example by fastening the top of the parachute canopy to the bottom of tank 2 using a breaking halyard.

The conical form of the nozzle 3 provides for transfer of effort from the surface of the flexible piston 6 to the area of section of the branch pipe 4; choosing this area together with the length of the branch pipe allows to make an additional adjustment of the speed of a jet, the width of the spillage and the concentration of fluid pushed out from the tank 2 per surface unit.

The flexible piston 6 is connected to the pull-out parachute 8 using the main flexible draft (link) 9, its own draft (link) 10 and the parachute canopy slings 11.

In its starting position the pull-out parachute 8 and the sling 9 can be stacked and fixed in a package near the tail hatch of the aircraft and supplied with a known means for inserting in the air flow on a command of the navigator (not shown in the figures).

The tank 2 may represent two coupled cylindrical tanks or a caissons (FIG. 2) with a common conic nozzle 3; each of them has the above described flexible piston 6 connected by its own draft 10 to the common draft 9 of the pull-out parachute 8.

The tank 2 is preferably mounted with an inclination aside the tail-end of the aircraft to prevent the jet of fluid from hitting the pull-out parachute 8.

Opening and closing of the outlet fitting of the tank is provided using the cock 12 (with manual or remote control) simultaneously with opening the lock 13 of draft transmission from the pull-out parachute 8 from the fuselage to the flexible piston 6.

For preserving and reusing the flexible piston 6 a disconnecting lock 14 (FIG. 1) may be applied having one part connected to slings 11, while the other part is connected to its own rod 10. When using the coupled tanks (FIG. 2) such locks 14 together with other components are used in each tank.

Disconnecting of parts of the lock 14 is provided for when the piston 6 enters the conical nozzle 3, under action of tension of an additional link (not shown), having one end attached to appropriate mechanism of disconnection of parts of the lock 14, and the other end to the face cover 15 of the bottom 7. Thus the given link may be passed through the opening in the parachute canopy of the piston-parachute 6 which edges are tightly adjacent to it.

For preserving and a reusing the pull-out parachute 8 as well both parts of the lock 14 can be connected among themselves with an additional sling of ˜5 m (not shown), that is freely stacked in a zigzag shape and attached to the case of the lock 14 when mounting the flexible piston 6 before refueling of tank 2 with fluid. Besides the second lock 16 is to be used connecting the slings of the pull-out parachute 8 to the rod 9, which (its continuation) is attached to the top of the parachute canopy.

Realization of the method according to the invention, in its preferred embodiment using the described device is carried out as follows.

Before a regular start the tank 2 of the aircraft is filled with water or extinguisher after having fixed as it is described above the pistons-parachutes 6 to the bottoms 7 and having connected them with the rod 9 of the pull-out parachute 8. The fluid is pumped through a branch pipe 5 when the cock 12 is opened, while maintaining the necessary drainage and control of refueling level. In the given configuration the use of ground-based refuelers is typical.

However it is possible to intake water when the airborne vehicle is flying at a low altitude above the water surface using a special sliding intake (as for example described in U.S. Pat. No. 4,172,499 A; 30 Oct. 1979).

When approaching the destination the tail hatch is to be opened to make the preliminary insertion of the pull-out parachute 8 in the approach air flow, while maintaining connection of its rod 9 with the fuselage using the lock 13 (FIG. 1). Thus required filling of parachute 8 and its stabilization in the air flow is reached.

In the given phase it may be provided if necessary the adjustment of the area of through section and/or of the length of the branch pipe 4 for receiving in a specific flight situation the optimum configuration of the fluid on the ground surface providing the maximal effect for establishing a long frontier.

Directly above the place of establishing the frontier (seat of fire) the cock 12 and the lock 13 are opened, the parachute 8 is rehooked from the fuselage to the slings 10 of flexible pistons 6 so that rod 9 triggers the pistons 6 that are displacing the fluid from the tank 2 densely adjoining to the tank (caissons) walls and adapting at the final phase of displacement to the conical nozzle 3.

The area of the pull-out parachute 8, the section and length of the outlet fitting 4 provide, at set speed and altitude of flight of the aircraft, the required outlet discharge and speed of fluid so that its jet appears practically motionless concerning the ground when jettisoning and during the subsequent fall would give a required frontier with a required covering and concentration in the frontier from which the backfire of vegetative cover would begin.

When the airlift of the airborne vehicle is 40 tons the length of the frontier can reach 2 km (for one mission).

In the version that maintains for reusing the pistons 6 and an pull-out parachute 8 the following final operations are carried out.

When the piston 6 enters the conical nozzle 3 the above-stated additional link between the lock 14 and the cover 15 stretches, and the mechanism of disconnecting the parts of the lock 14 operates. When these parts are disconnected the traction effort is removed from the pull-out parachute 8.

Since the given moment and till the moment of tensioning of the specified additional sling between the parts of the lock 14 the lock 16 opens (for example, due to a sharp decrease of the specified traction effort or at a remote command), disconnecting the slings of the parachute 8 from the rod 9. Thus the given parachute slips along the air flow being connected to the rod 9 only at the top of its canopy. The area of resistance of the parachute 8 to the approaching flow considerably decreases, allowing to retract this parachute by rods 10 and 9 back into the cargo compartment of the aircraft.

During the flight of the aircraft back to the place of refueling with the extinguisher all the system can be prepared for reuse.

The simplicity and efficiency of jettisoning the fluid provides for fast “turnover” of the process (the aircraft has time to accomplish a sufficient number of missions for a limited time), that in combination with high efficiency of dropping the fluid, provides significant economic benefit when isolating fires of any scale.

### INDUSTRIAL APPLICABILITY

For realizing the proposed method enough 20 simple and accessible technique is used. The method is partly tested onboard commercial aircrafts I1-76.

1. A method for jettisoning a fluid medium from a board of an airborne vehicle,
including pushing out of this medium from the tank mounted onboard the airborne vehicle using the displacing means subject to aerodynamic force of the air flow approaching the airborne vehicle during its movement, whereas a combined piston is used as displacing means, consisting of a parachute impenetrable for the fluid medium and connected to the latter using a flexible rod of the pull-out parachute that is to be entered in the air flow approaching the airborne vehicle for obtaining the specified aerodynamic force.

2. A method as claimed in claim 1, whereas the fluid medium is placed in a tank having a cylindrical part, connected through a conical part (nozzle) the a outlet part having the shape of a branch pipe.

3. A method as claimed in claim 2, whereas the speed of the fluid medium at the output of the outlet fitting equal to the absolute value of speed of movement of the airborne vehicle is obtained due to inserting the pull-out parachute in an air flow approaching the airborne vehicle.

4. A method as claimed in claim 2 or 3, whereas the tank is mounted with an inclination aside the tail-end of the airborne vehicle.

5. A method as claimed in claims 1-4, whereas the water or extinguisher based on other nonflammable fluid is used for the fluid medium.
